(19) United States
(12) Patent Application Publication
(10) Pub. No.: US 2011/0166881 A1
(43) Pub. Date: Jul. 7, 2011

(54) Method and system for generating food recommendations

(76) Inventors: Paul Eugene Brazzo, Allentown, PA (US); John William Krupa, Northampton, PA (US)

(21) Appl. No.: 12/655,851

(22) Filed: Jan. 7, 2010

(51) Int. Cl. G06Q 50/00; G06Q 30/00; G06Q 10/00

(52) U.S. Cl. 705/3

(57) ABSTRACT

In accordance with the principles of the present invention, a method and system of generating food recommendations is provided. A patient drug profile is provided listing currently prescribed medications for a patient. The patient drug profile is analyzed to establish an individual's medical condition(s), or disease state profile, from National Drug Code numbers, for example, in the patient drug profile. A nutritional database is provided. The nutritional database includes foods that are beneficial and/or harmful to various disease states. Food recommendations based on the individual's medical condition(s), or disease state profile, are provided from the nutritional database. The food recommendations can include both foods to avoid and foods to consume. Additional information, such as coupons, for example, based on the food recommendations, and a product location guide based on the food recommendations can be provided. In one implementation, the method and system of generating food recommendations can be provided in a pharmacy management system within a grocery store. In another implementation, the method and system of generating food recommendations can be provided using any computing device.

### FIELD OF THE INVENTION

The present invention relates generally to pharmacy management systems in retail pharmacies. The present invention also relates generally to other computing devices using online connections, or to those without online connections, such as kiosks or similar interactive devices, capable of utilizing proprietary software for specific purposes.

### BACKGROUND OF THE INVENTION

Retail pharmacy operation has become a highly-intensive, computer-driven enterprise. Pharmacy systems in retail pharmacies typically feature pharmacy management, prescription processing, third party billing, and point of sale functions. Newer features include medication therapy management (MTM), automated dispensing, and internet consumer portals which seek to accommodate the expanding role of the pharmacist in today's healthcare delivery system.

In recent years, various systems have been used to generate advisory and other information for pharmacy patients, based principally on the identification of the prescription drug being dispensed. Prescription drugs in the United States are uniquely identified by a National Drug Code (NDC). The NDC for a prescription drug is typically entered into the pharmacy management system by the pharmacist or a technician during initial steps in the dispensing process and may be encoded on the product itself in bar code form. Currently, advisory, counseling, and other relevant information for the patient is based upon the given NDC of a single drug, capable only of providing discrete informational segments, corresponding to individual drugs, even when multiple drugs are dispensed. In addition, there is currently no system that merges disciplines within the allied health professions to promote better health and wellness in the population.

### SUMMARY OF THE INVENTION

In accordance with the principals of the present invention, a method and system of generating food recommendations is provided. A patient drug profile is provided listing currently prescribed medications for a patient. The patient drug profile is analyzed to establish an individual's medical condition(s), or disease state profile, from National Drug Code numbers, for example, in the patient drug profile. A nutritional database is additionally provided. The nutritional database includes foods that are beneficial and/or harmful to various disease states. Food recommendations based on the individual's medical condition(s), or disease state profile, are provided from the nutritional database. The food recommendations can include both foods to avoid and foods to consume. Additional information, such as coupons, for example, based on the food recommendations, and a product location guide based on the food recommendations can be provided. In one implementation, the method and system of generating food recommendations can be provided utilizing a pharmacy management system in a grocery store. In another implementation, the method and system of generating food recommendations can be provided using any computing device.

### BRIEF DESCRIPTION OF THE DRAWINGS

FIG. 1 is a schematic of a non-limiting example hardware architecture that can be used to operate the system of the present invention.

FIG. 2 is a hieratical flow-chart in accordance with the principals of the present invention.

FIG. 3 is an example food opportunity alert in accordance with the principals of the present invention.

FIG. 4 is an example detailed food recommendation window or screen in accordance with the principals of the present invention.

FIG. 5 is an example patient record in accordance with the principals of the present invention.

### DETAILED DESCRIPTION OF A PREFERRED EMBODIMENT

The present invention lies within a broader context of pharmacy management systems. The present invention goes beyond the provision of printed material of an advisory or informational sort, based upon the given NDC of a single drug, by positively impacting human behavior through face to face encounters, thus promoting better health and wellness in the population. The present invention also possesses the quality of broad applicability in that any member of the allied health professions, who shares an interest in promoting better health and wellness in the population, can benefit from its use.

Prior to the present invention, pharmacy management systems have not ventured into the realm of expanding the health and wellness platform within the retail environment by generating comprehensive food recommendations whose nutritional components may benefit or support the management of specific diseases. Both chronic and acute diseases—such as, for example, diabetes, arthritis, gout, urinary tract infection, digestive diseases and disorders, heart disease, osteoporosis, obesity, etc.—can be favorably impacted when dietary measures are implemented, as part of an overall treatment plan. Arthritis, for example, is a chronic disease of inflammation. Anti-inflammatory drugs, such as NSAIDs (Non-Steroidal Anti-Inflammatory Drugs) (for example, ibuprofen, naproxen, etc.), are frequently prescribed to reduce pain and inflammation. Yet, specific foods can have anti-inflammatory effects as well.

For example, omega-3 fatty acids decrease inflammation by suppressing the production of cytokines and enzymes that erode cartilage. Many studies have demonstrated that omega-3 fish oils, found in wild salmon for instance, can reduce symptoms of rheumatoid arthritis. See, for example, Cleland L G, James M J, Proudman S M. Fish oil: what the prescriber needs to know. Arthritis Research and Therapy. 2005; 8(1):202. Study participants reported greater strength, less fatigue, reduced joint swelling and tenderness, less joint stiffness, and less pain.

Other foods, such as, walnuts and anchovies for example, also rich in omega-3 fatty acid content, possess similar anti-inflammatory properties. Yet, some foods—such as those containing refined sugars, saturated or trans fats—actually increase inflammation. Thus, by utilizing the present invention the consumer/patient can be assisted in constructing a more healthful diet which positively impacts a chronic inflammatory disorder by introducing beneficial foods that may, perhaps, be unfamiliar, yet which have the potential to become dietary favorites, replacing more harmful, inflammatory foods.

As a further example, acute urinary tract infections are treated with appropriate anti-infective drugs (for example, ciprofloxacin). Susceptible patients/consumers may be interested in food selections such as unsweetened cranberry juice, for example, which, according to retrospective controlled trials, significantly reduced the incidence of recurrent urinary tract infections at twelve months. See, for example, Raz R, Chazan B, Dan M. Cranberry Juice and Urinary Tract Infection. Clin Infect Dis. 2004 May 15; 38(10):1413-9. Epub 2004 Apr. 26. Cranberries contain two compounds with antiadherence properties that prevent bacteria such as E. coli from adhering to uroepithelial cells in the urinary tract, thus illustrating the beneficial role of unsweetened cranberry juice in preventing urinary tract infections.

The grocery store, although not the only retail setting in which prescription and food sales coexist, perhaps best illustrates the usefulness of the present invention. The existence of licensed pharmacies within grocery stores is common today. Indeed, more and more grocery stores not only sell food and dispense pharmaceuticals, but also provide medical care, offered in the form of free-standing clinics on the premises, staffed by nurse practitioners, physician assistants, or even in some cases, physicians. Yet, prior to the present invention, true integration of services with respect to the dietary and nutritional aspects of maintaining good health, together with pharmaceutical care, and basic medical care, was lacking.

Prior to the present invention, there was no integrated vehicle, directly driven by a pharmacy management system, with which to extend a health and wellness agenda into the grocery aisle. The pharmacist, as wellness educator, is the most accessible health care professional in the health care system, and is uniquely positioned to assume an integral role in the health care community's overall effort to achieve positive outcomes in the lives of patients/consumers. The present invention aligns wholesome foods in the grocery aisles with the message emanating from health care providers, such as pharmacists, that choosing certain foods in favor of others can be a prescription for good health. The present invention, of course, is not limited to the pharmacy profession or to grocery stores. Other allied health professionals, such as, for example, physicians in general practice, nurse practitioners, physician assistants, dentists, registered dieticians, nutritionists, and anyone who shares an interest in addressing specific health disorders with nutritional interventions, can find utility in the present invention as well. In addition, even stand alone pharmacies that do not offer food products will find utility in offering healthful food recommendations to their patients and consumers.

In accordance with the principles of the present invention, a method and system of generating timely, appropriate food recommendations based not on one particular coded drug, but on an individual's current medical condition(s), or disease state profile, is provided. The food recommendation may include foods to avoid as well as foods to consume. The food recommendation is derived from a listing of drug codes, such as NDC (National Drug Code) numbers, representing currently prescribed medications for the individual patient. Such food recommendations can provide benefit or support in the management of certain health disorders, both chronic and acute, for patients/consumers in the retail or outpatient setting. The method and system of the present invention extends the health and wellness platform in the grocery, or drugstore retail setting in that safe, evidence-based food recommendations can emanate directly from the pharmacy. The reach of the pharmacist as wellness educator is thus extended in support of the nation's overall effort to reduce health care costs through dietary intervention. The present invention's capability of generating comprehensive food recommendations can be utilized as a basis to execute an ongoing food therapy management (FTM) program which addresses the changing health status of an individual.

In accordance with the principals of the present invention, a method and system which links a nutritional database with a coded medical condition(s), or disease state profile, is provided. The nutritional database includes foods that are beneficial and/or harmful to various disease states. The International Statistical Classification of Diseases and Related Health Problems (most commonly known by the abbreviation ICD), as published by the World Health Organization (WHO), provides codes to classify diseases. Every health condition can be assigned to a unique category and given an ICD code, up to six characters in length. Such categories can include a set of similar diseases. The ICD is revised periodically and is currently in its tenth edition.

ICD codes, or other disease identifiers, reflecting current medical conditions or disease states, are derived from drug codes, such as NDC numbers, listed in a patient's drug profile, or entered directly into the system by the pharmacist, to generate tentative medical condition(s), or a disease state profile, for the patient. The ICD codes, or other identifiers, in turn, are linked to a nutritional database to generate food recommendations.

The method and system of expanding the health and wellness platform within the retail setting can utilize existing pharmacy management systems to provide the pharmacist with scripted information based on the current medical condition(s), or disease state profile, of the patient. This information can appear as a prompt along the continuum of the prescription filling process, alerting the pharmacist of a potential opportunity to offer a particular food recommendation. The pharmacist, or other health care practitioner, would be responsible, using his/her professional judgment, to confirm and interpret the food recommendations before conveying to the patient/consumer.

In one aspect of the present invention, evidence-based food recommendations can be communicated to consumer/patients in the form of face-to-face encounters conducted by the pharmacist. In another aspect of the present invention, a web-based format, operating independently of a pharmacy management system, can be provided that allows other allied health professionals to expand their own wellness programs by entering disease state information, or corresponding identifiers, such as ICD codes, directly into the system to obtain comprehensive food recommendations and other useful information. Another aspect of the present invention can be provided that allows consumers to utilize interactive computer devices such as kiosks, for example, operating independent of a pharmacy management system, to generate specific food recommendations relating to certain medical conditions or disease states. In another aspect of the present invention, consumer applications, such as on-line portals which utilize the method and system of generating food recommendations, can be provided. This aspect affords the consumer/patient the opportunity to pose queries, or to view their current food recommendations on-line, as generated by their current medical condition(s), or disease state profile, through their pharmacy or other health care provider.

In another aspect of the present invention, a method and system of generating printed material, using point of sale or other ancillary message systems, in the form of food recommendations and related information, such as, for example, special diets or recipes including such foods, based upon the patient's current medical condition(s), or disease state profile, is provided. This could serve as a reference, reminder, and appendage to the information offered by the pharmacist. In another aspect of the present invention, a method and system of contemporaneously providing the consumer/patient with savings coupons and a product location guide which correspond to food recommendations using point of sale systems is provided.

Thus, the present invention utilizes drug information, such as the language of NDC codes, to derive medical condition(s), or disease state profile, as stated in the language of ICD codes or other unique identifiers, which are in turn linked to a nutritional database, to generate food recommendations that may benefit or support the management of specific health disorders. The medical condition(s), or disease state profile, can be modified or updated by the pharmacist to reflect the current health status of the patient, thus providing accurate and comprehensive food recommendations, or generated as a hypothetical to provide impromptu food recommendations for purposes of discussion.

In more detail, prescription processing begins with the input of the patient's demographic and insurance data, if not already present in the pharmacy management system, to create a patient record. This is followed by input, by a pharmacist or pharmacy technician, of the drug, quantity, directions for use, number of authorized refills, prescribing physician, original date, method of receipt (written, telephone verbal, electronic or facsimile), and drug substitution information. Once this information has been entered into the pharmacy management system, a series of checks or edits is initiated by the system and/or concerned third parties (for example, payors). These checks or edits address a variety of issues including, but not limited to, contraindications of the prescribed medication, interactions with other medications or foods, duplication of therapy, appropriateness of dose and/or frequency prescribed, and suggestion of less costly alternatives, etc.

The various halts, edits, checks, and reviews, in pharmacy parlance sometimes collectively referred to as drug utilization review or DUR edits, essentially confer an interruptive quality to the process of filling a prescription, requiring the pharmacist to engage and reconcile messaging at various intervals in order to proceed to the end stage of billing the patient and/or third party successfully and generating a prescription label. One embodiment of the present invention inserts a food recommendation opportunity into this region of the pharmacy management system landscape. At some point, along this continuum of processing the prescription, the present invention allows for a food recommendation alert to appear and prompts the pharmacist to view and/or print scripted information intended to be personally conveyed to the patient.

In recent years, the role of the pharmacist in the retail setting has expanded beyond the dispensing function to areas such as detailed medication counseling, immunization, medication therapy management (MTM), diabetes education, and wellness education. The MTM process entails the collection of patient information including, but not limited to, drug and/or food allergies, current medications (prescription and over the counter), current diagnoses, special dietary considerations, etc., to conduct activities such as executing potential cost saving measures in cooperation with the prescribing physician, appropriateness of therapy assessments, etc. In the course of his/her professional practice, it is not inappropriate to elicit disease state information from the patient. In doing so, the pharmacist is able to clarify the patient's current medical condition(s), or disease state profile, thereby confirming the accuracy of the invention's end product, namely, food recommendations which may benefit or support the management of certain health disorders.

In this regard, the present invention system allows for adjustment of the current medical condition(s), or disease state profile, in the event ICD codes, or other unique identifiers are indicating multiple disease states for any given NDC. The pharmacist can modify the current medical condition(s), or disease state profile, to reflect the current health status of the patient, thereby ensuring the accuracy and appropriateness of the food recommendations. If time permits, a comprehensive food recommendation based on the current medical condition(s), or disease state profile of the patient, can be conveyed personally. The invention's concept of Food Therapy Management (FTM) can be implemented to encompass a range of safe, unbiased, evidence-based dietary and nutritional information that might include special diets, complimentary vitamin and/or herbal supplementation, recipes that include the food recommendations, foods to avoid, drug/food interactions, food recommendations which may be suitable for one particular disease state but contraindicated in the presence of another, etc.

If time is short, as is often the case in the retail pharmacy setting, an abridged recommendation, in the form of, perhaps, “today's food for thought”, can be proffered. For example, “today's food for thought” could convey a single food that, if incorporated into the patient's diet on a consistent basis, can provide benefit. For example, as previously described, consumption of unsweetened cranberry juice to reduce the incidence of recurrent urinary tract infections (if not contraindicated in consideration of the patient's other disease states, food allergies, and/or current drug therapy), could serve as such an abridged recommendation.

The patient/consumer may have a question regarding a particular food and its relationship to a given disease state, in which case, in one embodiment, the invention's methods and systems allow for a food recommendation based on a hypothetical. By simply entering a given disease state, or combination thereof, this embodiment can generate a series of food recommendations that might include foods to avoid (more than moderate quantities of beer with respect to gout, for example) as well as foods to consume (bran for constipation, for instance). The pharmacist, or other allied health professional utilizing the invention, shall inform the patient/consumer that the food recommendation offered, although safe and evidence based, is not intended as medical advice, nor as a substitute for any treatment that has been prescribed by the physician.

In another embodiment, the present invention's methods and systems allow for use of the nutritional database by other members of the allied professions, in a web based format, such that input of a specific disease states will generate food recommendations that may provide benefit or support in disease management. This embodiment utilizes the nutritional database's inherent capability of generating food recommendations from specific medical conditions in environments additional to a pharmacy management system. A further embodiment allows the patient/consumer to view their current food recommendations on-line, or to pose queries regarding medical conditions and their relationship to dietary factors, as a value added service offered by their pharmacy or other health care provider

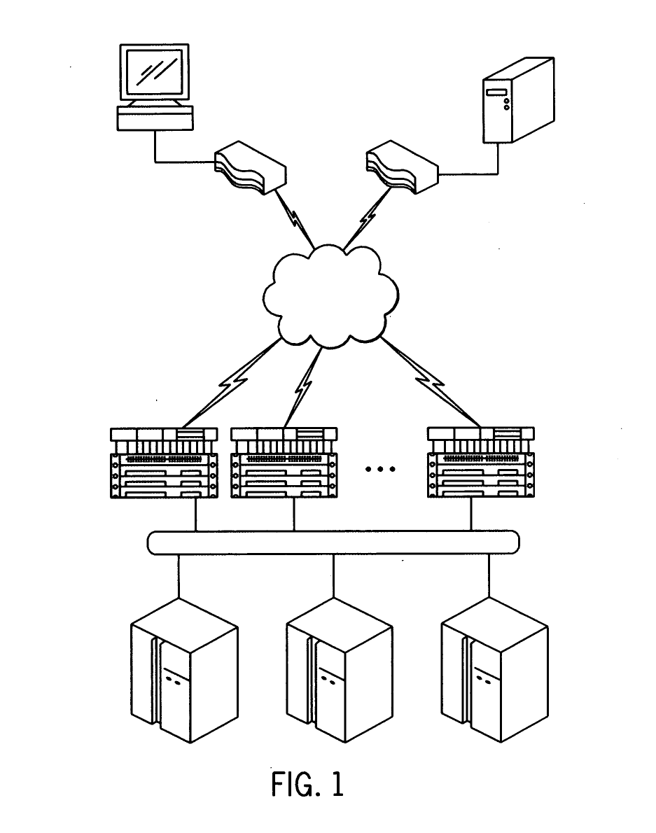

Referring to FIG. 1, a non-limiting example of a high level implementation that can be used to run a system of the present invention is seen. The infrastructure should include but is not limited to: wide-area network connectivity; network infrastructure; an operating system such as for example Redhat Linux Enterprise Linux AS Operating System available from Red Hat, Inc., 1801 Varsity Drive, Raleigh, N.C.; appropriate network switches and routers; electrical power (backup power); network backup hardware and software, and message software such as for example Tibco SmartSockets messaging software available from Tibco Software Inc., 3303 Hillview Avenue, Palo Alto, Calif.

A match engine and administrative applications server can run for example on an HP Proliant DL740 server with 4 3.0 GHz processors, 64 GB or RAM, 60 GIG Raid level 1 and 1 GHZ network connection, available from the Hewlett-Packard Company, 3000 Hanover Street, Palo Alto, Calif. The database server (2) can be run for example on an HP Proliant DL740 server with 4 3.0 GHz processors, 64 GB or RAM, 300 GIG Raid level 3 and two 1 GHZ network connections, and an active backup system, capable of backing up and restoring while the system is active. The order routing and management applications can be run for example on HP Proliant DL360 server with 2 3.6 GHz processors, 8 GB or RAM, 60 GIG Raid level 1 and 1 GHZ network connection, also available from the Hewlett-Packard Company.

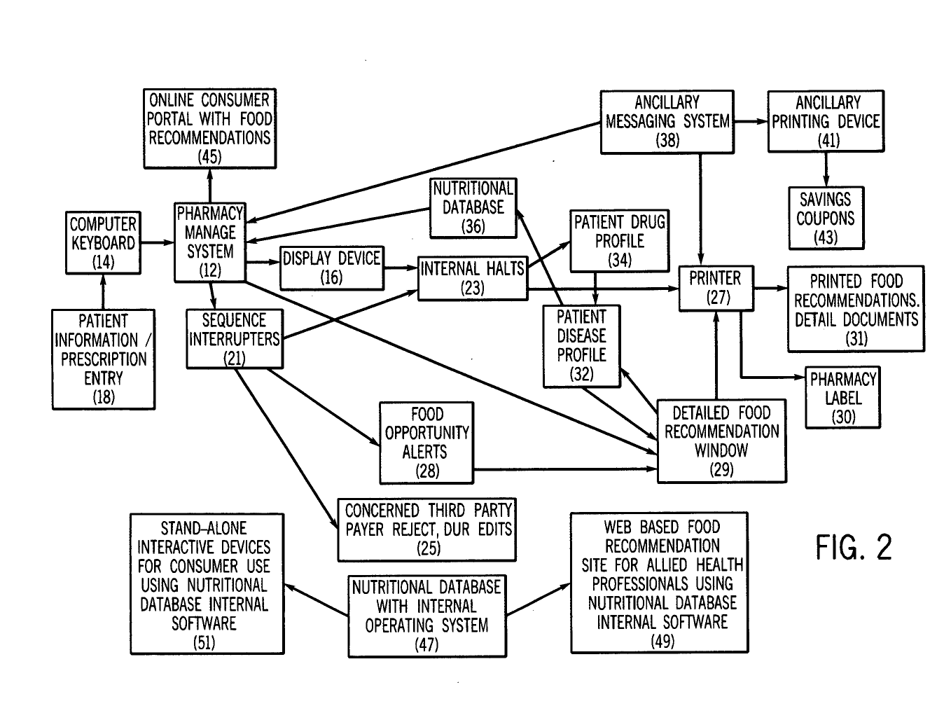

Referring to FIG. 2, a hieratical flow-chart in accordance with the principals of the present invention is seen. A pharmacy management system is contained within a central processing unit 12. A computer monitor screen 14 and an input device such as a keyboard 16 are provided. As previously described, the pharmacist, or pharmacy technician, enter into the pharmacy management system prescription data such as patient, medication, prescriber, and insurance, constituting an initial step in prescription processing (18).

Various halts (21, 23, 25) are incorporated into the pharmacy management system. The halts (21, 23, 25) function to direct prescription processing through a system of checks, edits, alerts, and messaging, which ultimately ensure accuracy of the transmission, appropriateness of therapy, patient safety, and monitoring of clinical outcome. Examples of halts can include allergy alerts, food/drug precautions, food/drug interactions, possible drug/disease contraindications, drug utilization review alerts (drug/age precautions, therapeutic duplication, etc.), drug/drug interactions, etc. These halts require engagement and reconciliation by the pharmacist, utilizing his/her professional judgment, in order to proceed to the final stage of prescription processing. In this final stage, a prescription label 30 is generated, utilizing the pharmacy management system's printer device 27, and the medication is dispensed.

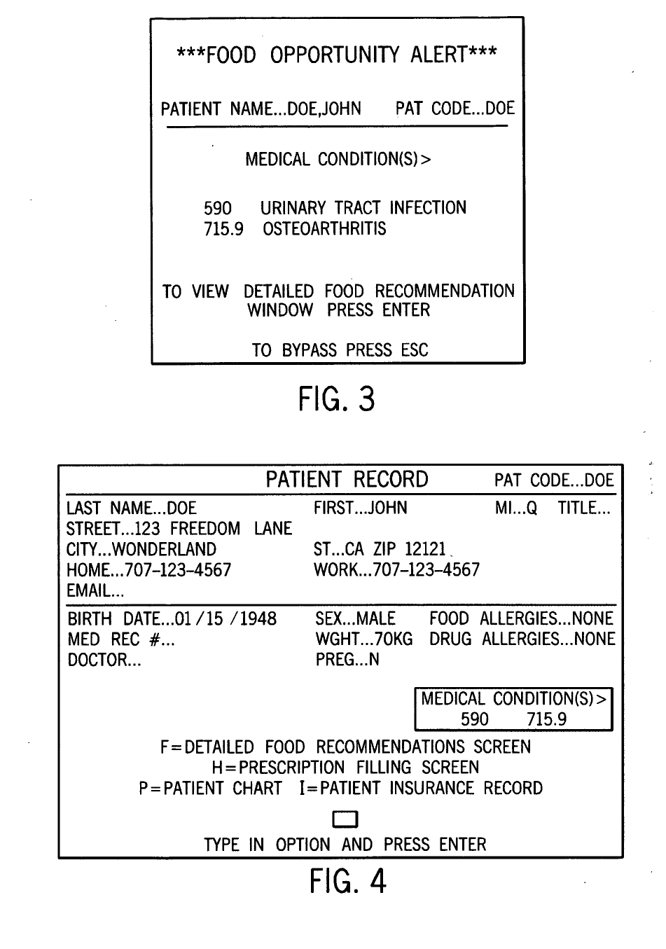

In accordance with the principals of the present invention, an additional halt is inserted into the pharmacy management system. Like other sequence interruptions in the pharmacy management system described above, this new halt, which could be referred to as a “food opportunity alert” 28, engages the pharmacist to interact directly in order to proceed. Referring to FIG. 3, an example food opportunity alert is seen. The food opportunity alert can include information about the patient and indicate the patient's medical conditions. In the example shown in FIG. 3, the patient has two unique identifiers in the form of ICD codes 590 and 715.9, indicating that the patient suffers from osteoarthritis and urinary tract infection. At this juncture, the pharmacist is given the opportunity to view, or not to view, a detailed food recommendation window 29. The food opportunity alert includes a route or link to a detailed food recommendation window 29.

Referring to FIG. 4, an example detailed food recommendation window is seen. The detailed food recommendation window 29 can include patient identification and information relating to drug or food allergies, as retrieved from the pharmacy management system's patient record. The detailed food recommendation window 29 features a listing of the given patient's current medical condition(s), or disease state profile. The disease state profile can be updated by the pharmacist at any time for sake of accuracy, or in response to any changes in the patient's health status. ICD codes, or other identifiers, are used to codify. The food opportunity detailed recommendation screen 29 can include function and medical condition data entry. Various operations can be provided, including for example, (A) adding a medical condition, (U) updating the medical condition list or disease state profile, (D) deleting a medical condition, (H) testing a hypothetical, (S) searching for a medical condition, and (P) printing any information accessible to the user. The detailed food recommendation window 29 also details food recommendations for the individual patient, based on his/her current medical conditions or disease states. The detailed food recommendation window 29 can include foods to consume as well as foods to avoid, as generated from the interface of a nutritional database with a coded disease state file. The detailed food recommendation window 29 can also include links to detail documents, such as, for example, scientific explanation, literature citations, recipes, advice related to complementary vitamin and/or herbal supplementation, etc. The detailed food recommendation window 29 can be made available to the pharmacist on demand at anytime.

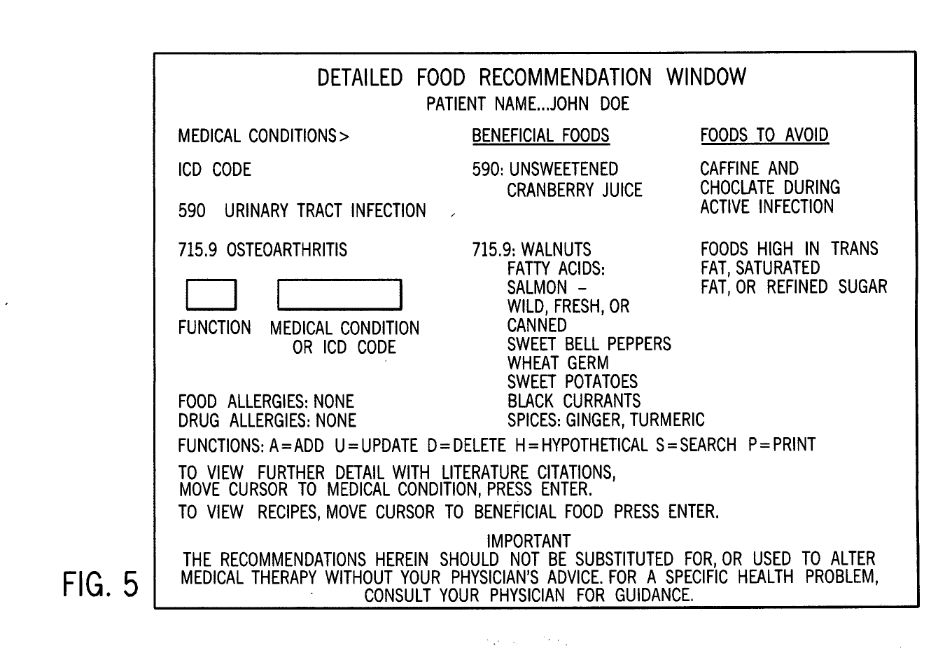

In another embodiment, the user can access the detailed food recommendation window 29 from the patient record. Referring to FIG. 5, an example patient record is seen. The patient record screen can include demographic information about the patient, information related to the patient's medical condition, and information related to food and/or drug allergies. In the example shown in FIG. 4, the patient has two unique identifiers in the form of ICD codes 590 and 715.9, again indicating that the patient suffers from osteoarthritis and a urinary tract infection.

That a user can gain direct access to a detailed food recommendation window 29 from the patient record is seen. In this example, a user selects option “F” to view the detailed food recommendation window at any time, and can perform various operations including, for example, testing hypothetical inquiries and/or updating medical condition(s) or disease state profile, as per changes in health status, to obtain accurate food recommendations. Examples of additional links, or routes through the pharmacy management system, can include a prescription filling screen, a patient chart, and patient insurance records.

As previously described, the given patient's current medical condition(s), or disease state profile, is inferred from a listing of currently prescribed medications in the patient's drug profile. The present invention links ICD codes 32, or other unique identifiers, to specific drug codes, such as NDC numbers 34, to generate a tentative medical condition(s), or disease state profile for the patient. The ICD codes, or other unique identifiers, interface with a nutritional data base 36 to generate food recommendations. The system can eliminates food(s) from the recommendation that may be contraindicated in any particular disease state, interact with any medication currently prescribed, or which constitute a food to which the patient may be allergic.

The patient's medical condition(s), or disease state profile, can be updated on the detailed food recommendation window 29 to reflect the current health status of the patient to ensure appropriate and timely food recommendations as part of a comprehensive food therapy management (FTM) program. In addition, entry of hypothetical medical conditions or disease states can be provided which correspond to food recommendations for purposes of discussion and/or counseling with the patient. The screen's print option provides the pharmacist with scripted information with which to conduct a face-to-face encounter with the patient, conveying food recommendations and related detail documents. Subsequently, a hard copy can be offered to the patient for reference.

Ancillary messaging systems 38 can be provided, which interface with the pharmacy management system, to append data to the prescription label's informational section, or apart from the prescription label utilizing the pharmacy printer's secondary tray. Such systems are capable of printing recipes which may include food recommendations. An ancillary message system's printing device 41 which may be used to print savings coupons 43 for food recommendations can be provided.

In a further embodiment in accordance with the principals of the present invention, a nutritional database with internal operating system 47 can be provided. In one aspect of this further embodiment, Internet consumer portal applications 45 can interface with the pharmacy management system, affording the patient/consumer the opportunity to view current food recommendations on-line, or to pose queries regarding medical conditions and their relationship to dietary factors. In a further aspect of this further embodiment, a web-based site 49, operating independently of a pharmacy management system, and available to pharmacists and allied health professionals interested in generating food recommendations based on a profile of certain medical conditions, can be provided. In a further aspect in accordance with the principals of the present invention, stand-alone interactive devices 51, such as kiosks or similar hardware, can afford consumer/patients direct access to the invention's unique method and system of generating food recommendations through inquiry regarding specific health concerns.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A method of generating food recommendations comprising:
on a computer, analyzing a patient drug profile having currently prescribed medications for an individual patient;
on a computer, establishing an individual's medical condition(s), or disease state profile, from the patent drug profile;
on a computer, establishing, via a nutritional database, food recommendations based on the individual's medical condition(s), or disease state profile; and
displaying the food recommendations.

2. The method of generating food recommendations of claim 1 further comprising analyzing a listing of drug codes in a patient drug profile having currently prescribed medications for an individual patient.

3. The method of generating food recommendations of claim 2 further comprising analyzing National Drug Code numbers in a patient drug profile having currently prescribed medications for an individual patient.

4. The method of generating food recommendations of claim 1 further comprising establishing an individual's medical condition(s), or disease state profile, in accordance with the International Statistical Classification of Diseases and Related Health Problems, as published by the World Health Organization.

5. The method of generating food recommendations of claim 4 further comprising establishing an individual's medical condition(s), or disease state profile, in accordance with any codified method of disease classification utilized by any given pharmacy management system.

6. The method of generating food recommendations of claim 1 further comprising displaying the food recommendations on a computer monitor.

7. The method of generating food recommendations of claim 1 further comprising printing the food recommendations.

8. The method of generating food recommendations of claim 1 further comprising displaying the food recommendations via an interne.

9. The method of generating food recommendations of claim 1 further comprising displaying the food recommendations via stand-alone interactive devices.

10. The method of generating food recommendations of claim 1 further comprising providing a comprehensive food recommendation selected from the group comprising food recommendations, diets, recipes, drug/food interactions, food/disease state contraindications, food allergies, complimentary vitamin and/or herbal supplementation, related dietary and/or medical information, literature citations, and combinations thereof.

11. The method of generating food recommendations of claim 1 further comprising providing an abridged food recommendation.

12. The method of generating food recommendations of claim 1 further comprising establishing, via a nutritional database, recommendations on foods to consume.

13. The method of generating food recommendations of claim 1 further comprising establishing, via a nutritional database, recommendations on foods to avoid.

14. The method of generating food recommendations of claim 1 further comprising providing discounts based on the food recommendations.

15. The method of generating food recommendations of claim 14 further comprising providing coupons based on the food recommendations.

16. The method of generating food recommendations of claim 1 further comprising providing a product location guide based on the food recommendations.

17. The method of generating food recommendations of claim 1 further comprising enabling manual alteration of the medical condition(s), or disease state profile.

18. The method of generating food recommendations of claim 17 further comprising enabling manual alteration of the medical condition(s), or disease state profile, as a hypothetical to provide impromptu food recommendations for purposes of discussion.

19. The method of generating food recommendations of claim 1 further comprising eliminating food(s) from the recommendation that may be contraindicated in any particular disease state, interact with any medication currently prescribed or which constitute a food to which the patient may be allergic.

20. The method of generating food recommendations of claim 1 further wherein the method of providing food recommendations is provided on a pharmacy management system.

21. The method of generating food recommendations of claim 20 wherein the pharmacy management system is in a grocery store.

22. A pharmacy management system comprising:
a patient drug profile comprising currently prescribed medications for a patient;
a system halt, the system halt comprising a food opportunity alert comprising at least one medical condition or disease state and at least one food recommendation derived from analyzing the patient drug profile;
displaying and/or printing of at least one food recommendation; and
a label printed for a prescription.

23. The pharmacy management system of claim 22 further wherein the patient record comprises demographic, insurance, allergy (food and drug), and medical condition(s) data for a patient.

24. The pharmacy management system of claim 22 further wherein the patient drug profile comprises at least a prescription number, drug, quantity, directions for use, number of authorized refills, prescribing physician, original date, refill history, method of receipt, and drug substitution information.

25. The pharmacy management system of claim 22 further comprising additional halts selected from the group comprising drug/disease contraindications, food/drug precautions, food/drug interactions, drug/drug interactions, drug/age precautions, therapeutic duplication, appropriateness of dose and/or frequency prescribed, suggestion of less costly alternatives, allergy alerts, and combinations thereof.

26. The pharmacy management system of claim 22 further comprising at least one food recommendation derived from an individual's medical condition(s), or disease state profile, derived from the patent drug profile.

27. The pharmacy management system of claim 22 further comprising at least one food recommendation derived via a nutritional database based on the patient drug profile.

28. The pharmacy management system of claim 22 further comprising the label printed for a prescription using a pharmacy printer's primary or upper tray.

29. The pharmacy management system of claim 28 further comprising a printed food recommendation utilizing the pharmacy printer's secondary tray.

30. The pharmacy management system of claim 29 further comprising a printed detail document including specific food recommendations and providing related and in depth dietary and/or medical information including special diets and recipes, literature citations, and advice related to complimentary vitamin and herbal supplementation.

31. The pharmacy management system of claim 22 further comprising at least one food to consume.

32. The pharmacy management system of claim 22 further at least one food to avoid.

33. The pharmacy management system of claim 22 further comprising discounts based on the food recommendations.

34. The pharmacy management system of claim 33 further comprising coupons based on the food recommendations.

35. The pharmacy management system of claim 22 further comprising providing a product location guide based on the food recommendations.

36. The pharmacy management system of claim 22 wherein the pharmacy management system is in a grocery store.

37. A food recommendation system comprising:
a user interface that enables users to enter information on a given disease;
a nutritional database with internal operating system relating dietary factors to various diseases; and
at least one food recommendation derived via the nutritional database based on a given disease.

38. The food recommendation system of claim 37 further wherein information related to a disease comprises disease state information.

39. The food recommendation system of claim 37 further wherein information related to a disease comprises ICD codes.

40. The food recommendation system of claim 39 wherein information related to a disease comprises any internal coding system used to classify disease.

41. The food recommendation system of claim 37 further wherein the food recommendation system is comprised in a web-based format.

42. The food recommendation system of claim 37 further wherein the food recommendation system is comprised in a kiosk.

43. The food recommendation system of claim 42 further comprising providing a product location guide based on the food recommendations.

44. The food recommendation system of claim 37 further wherein the food recommendation system is comprised in an on-line portal.

45. The food recommendation system of claim 37 further comprising a printed food recommendation.

46. The food recommendation system of claim 45 further comprising a printed, fully referenced, related detail document including specific food recommendations, and providing related, in depth dietary and/or medical information including, but not limited to, special diets and recipes, and advice related to complimentary vitamin and herbal supplementation.

47. The food recommendation system of claim 37 further comprising at least one food to consume.

48. The food recommendation system of claim 37 further at least one food to avoid.

49. The food recommendation system of claim 37 further comprising discounts based on the food recommendations.

50. The food recommendation system of claim 49 further comprising coupons based on the food recommendations.
